(19) United States
(12) Patent Application Publication
(10) Pub. No.: US 2007/0169347 A1
(43) Pub. Date: Jul. 26, 2007

(54) Method of making vehicle wheel rim

(76) Inventor: Ting-Fang Wang, Taipei Hsien (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/716,966

(22) Filed: Mar. 12, 2007

Related U.S. Application Data
(63) Continuation-in-part of application No. 11/193,109, filed on Jul. 30, 2005, now abandoned.

(30) Foreign Application Priority Data
Sep. 22, 2004 (TW) 093128709

(51) Int. Cl. B23P 17/00

(52) U.S. Cl. 29/894.35

(57) ABSTRACT

A method of making a vehicle wheel rim includes the steps of: deep drawing a metal plate to form a substantially cylindrical blank having two axially opposite first and second open end portions; roll-bending a ring portion of the cylindrical blank between the open end portions so that the ring portion is bent inwardly and substantially radially; placing into a mold the cylindrical blank that has been bent; forcing upper and lower press members respectively into the open end portions of the cylindrical blank; and forming the open end portions by pressing the open end portions against a cavity wall of the mold using lateral faces of the press members, and pressing two opposite sides of the bent ring portion to form a folded annular protrusion using end faces of the press members which are transverse to the lateral faces thereof, thereby providing a wheel rim body.

### CROSS-REFERENCE TO RELATED APPLICATION

This application is a continuation-in-part of U.S. patent application Ser. No. 11/193,109, filed by the applicant on Jul. 30, 2005, the entire disclosure of which is incorporated herein by reference.

### BACKGROUND OF THE INVENTION

1. Field of the Invention

The invention relates to a method of making a vehicle wheel rim.

2. Description of the Related Art

Referring to FIG. 1, a first conventional vehicle wheel rim 1 is made by first forming an elongated aluminum plate 11 (shown in phantom lines) by extrusion. The aluminum plate 11 is provided with a plurality of parallel ribs 12 (only two ribs 12 are shown) projecting integrally along the length thereof. The aluminum plate 11 then undergoes roll bending so as to form a tubular shape. Two ends of the aluminum plate 11 are subsequently welded together so as to form a wheel rim body 13, and the ribs 12 which are located inside the wheel rim body 13 are bored with a plurality of angularly spaced-apart holes 121 to facilitate fastening of a central disc 14 to the wheel rim body 13.

However, precision in the roundness of the wheel rim body 13 is not easily achieved during production. Further, since the two ends of the aluminum plate 11 are connected together by a welding process, heat produced during the welding process degrades the material of the wheel rim 1 so that stress is concentrated in this area of connection during use of the wheel rim 1. This may lead to a dangerous situation. Hence, the first conventional wheel rim 1 is unsafe to use. Moreover, when a tire is mounted on the wheel rim 1, the welded ends of the aluminum plate 11 can cause air leakage in the tire as a result, for example, of the uneven surface introduced by the welds.

Referring to FIG. 2, a second conventional wheel rim 2 includes a left annular body 21, a right annular body 22, and a central disc 23. The left and right annular bodies 21, 22 are made by punching and drawing processes. The central disc 23 is clamped between the left and right annular bodies 21, 22, and is fastened therebetween through a plurality of screws 24. The second conventional wheel rim 2 has three components, i.e., the left and right annular bodies 21, 22 and the central disc 23. Hence, the second conventional wheel rim 2 has a relatively large number of components, thereby making manufacture of the second conventional wheel rim 2 complicated. Furthermore, a junction of the left and right annular bodies 21, 22 and the central disc 23 can cause air leakage in a tire mounted on the second conventional wheel rim 2.

Referring to FIG. 3, a third conventional wheel rim 3 includes a wheel rim body 31 and a central disc 32. The wheel rim body 31 is made as a single piece by a drawing process, and has an annular shoulder portion 311 formed in an inner face thereof. The central disc 32 is directly welded to the shoulder portion 311. Although the third conventional wheel rim 3 has a simple structure and is easy to make, heat produced during the welding process degrades the material of the wheel rim 3 to thereby result in the same aforementioned drawbacks of the first conventional wheel rim 1. Hence, the third conventional wheel rim 3 is also unsafe to use.

U.S. Pat. No. 2,051,501 discloses a method of making vehicle wheels in which wheels are formed by spinning/rolling. In particular, the patent discloses rolling of a cylinder of sheet metal so that the ends of the cylinder form bead ledges and bead retaining flanges. The center portion of the cylinder is also rolled to form two inwardly extending flanges which have their inner edges connected.

U.S. Pat. No. 7,107,809 discloses a method of shaping a seamless aluminum wheel which includes deep drawing a metal plate to form a cylindrical blank, followed by forming the cylindrical blank in a forming die using two opposite press members that form two end portions of the cylindrical blank, respectively, so that the two end portions are expanded.

### SUMMARY OF THE INVENTION

An object of the present invention is to provide a method of making a vehicle wheel rim that includes easy and simple steps.

According to this invention, a method of making a vehicle wheel rim comprises the steps of: deep drawing a metal plate to form a substantially cylindrical blank having two axially opposite first and second open end portions; roll-bending a ring portion of the cylindrical blank between the first and second open end portions so that the ring portion is bent inwardly and substantially radially; placing into a mold the cylindrical blank that has been bent; forcing upper and lower press members respectively into the first and second open end portions of the cylindrical blank placed in the mold, the upper and lower press members respectively having end faces that are opposite to each other, and lateral faces transverse to the end faces; and forming the first and second open end portions by pressing the first and second open end portions against a cavity wall of the mold using the lateral faces of the upper and lower press members, and pressing two opposite sides of the bent ring portion to form a folded annular protrusion using the end faces of the upper and lower press members, thereby providing a wheel rim body.

An important feature of the present invention resides in that the forming of the first and second open end portions of the cylindrical blank and the pressing of the bent ring portion are done using novel upper and lower press members.

Another important feature of the present invention resides in the roll-bending of the ring portion of the cylindrical blank in which a pair of inner rollers is placed within the cylindrical blank proximate to the ring portion, and an outer roller disposed outside the cylindrical blank is moved toward the inner rollers so that the ring portion is bent between the inner rollers.

Still another important feature of the present invention resides in that the cylindrical blank is formed from the metal plate made of an unheat-treated aluminum alloy, and the wheel rim body formed from the cylindrical blank is heat treated to increase its strength.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective of a first conventional wheel rim;

FIG. 2 is an exploded sectional view of a second conventional wheel rim;

FIG. 3 is a sectional view of a third conventional wheel rim;

FIG. 4 is an exploded perspective view of a vehicle wheel rim made in accordance with the preferred embodiment of a method of the present invention;

FIG. 5 is an assembled sectional view of the vehicle wheel rim of FIG. 4; and

FIG. 6 illustrates the steps involved in making the vehicle wheel rim according to the preferred embodiment of the present invention.

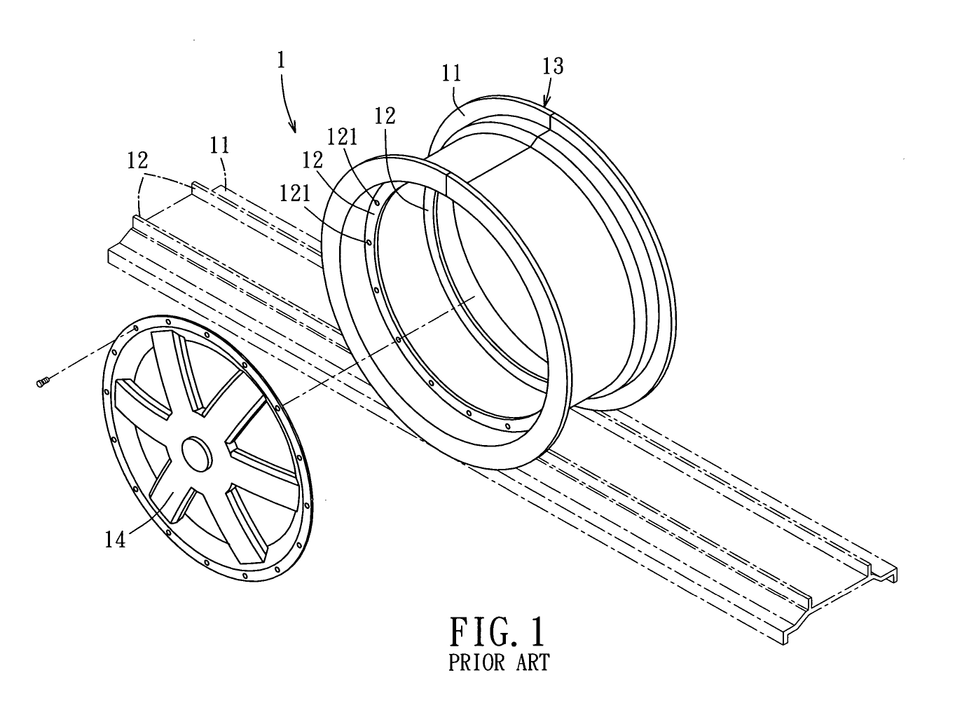

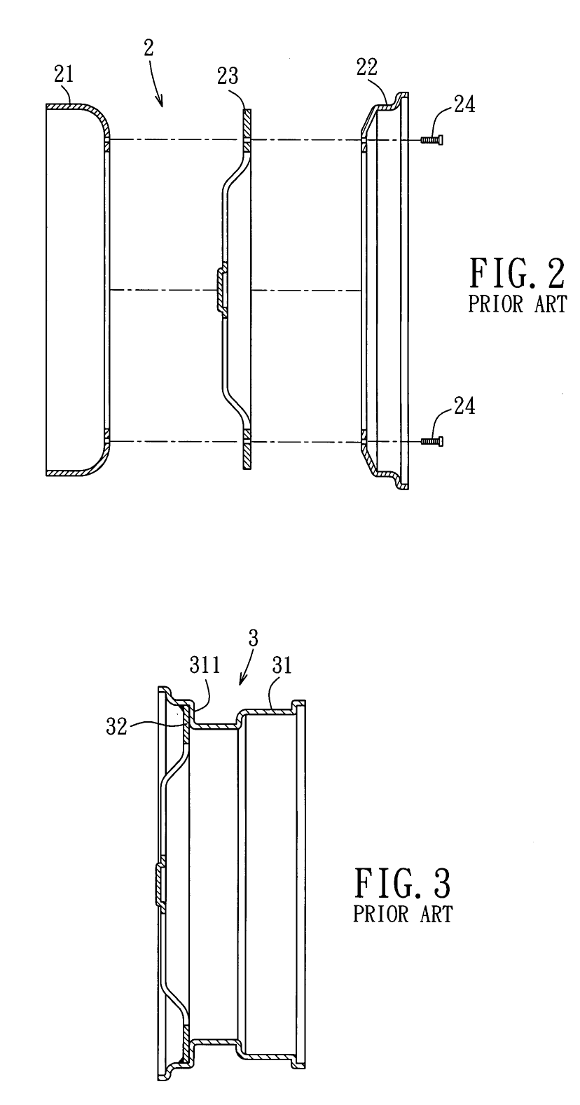

### DETAILED DESCRIPTION OF THE PREFERRED EMBODIMENT

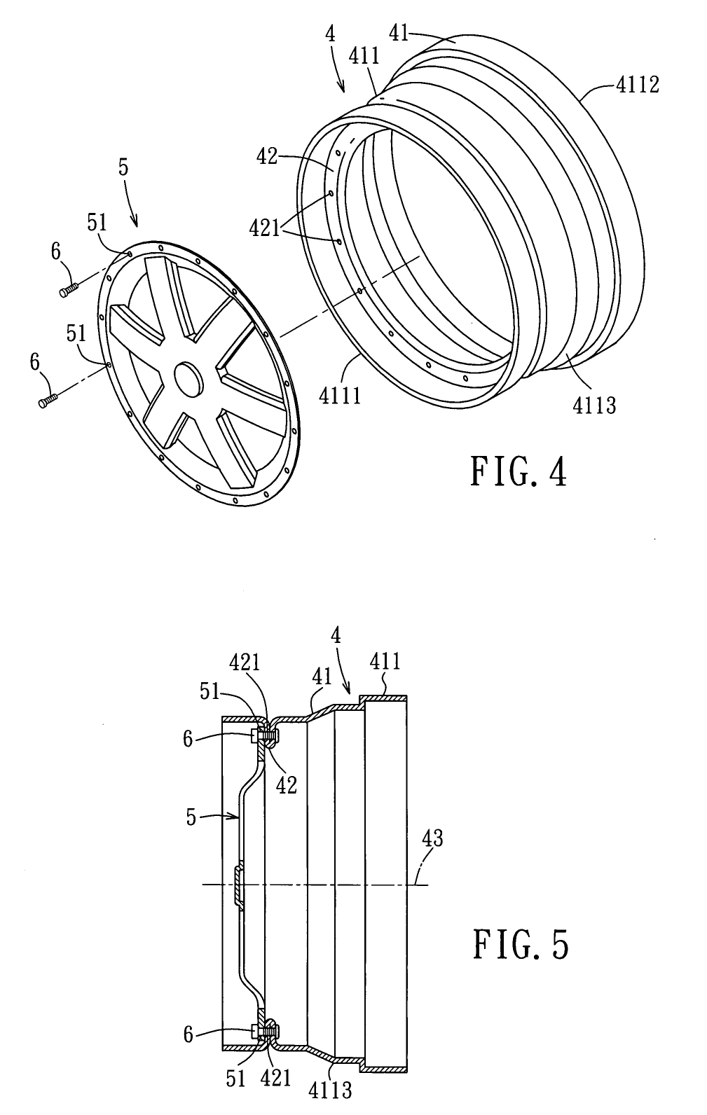

Referring to FIGS. 4 and 5, a vehicle wheel rim 4 made in accordance with the preferred embodiment of a method of the present invention is shown to comprise a wheel rim body 41, a central disc 5, and a plurality of fastening units 6.

The wheel rim body 41 has a tubular wall 411 and an annular protrusion 42. The tubular wall 411 is made by deep drawing an aluminum alloy plate, and has opposite first and second open end portions 4111, 4112. The aluminum alloy plate is a lightweight and strong material that exhibits good extendibility. The annular protrusion 42 projects radially, inwardly and integrally from the tubular wall 411 between the first and second open end portions 4111, 4112, and has a plurality of angularly spaced-apart through holes 421. The tubular wall 411 is formed with a plurality of stepped portions 4113 extending between the annular protrusion 42 and the second open end portion 4112.

The central disc 5 is seated against the annular protrusion 42, and has a plurality of angularly spaced-apart through holes 51 that correspond to the through holes 421 in the annular protrusion 42.

Each of the fastening units 6 is configured as a screw or bolt that extends through a respective one of the through holes 51 and a corresponding one of the through holes 421 so as to fasten the central disc 5 to the annular protrusion 42.

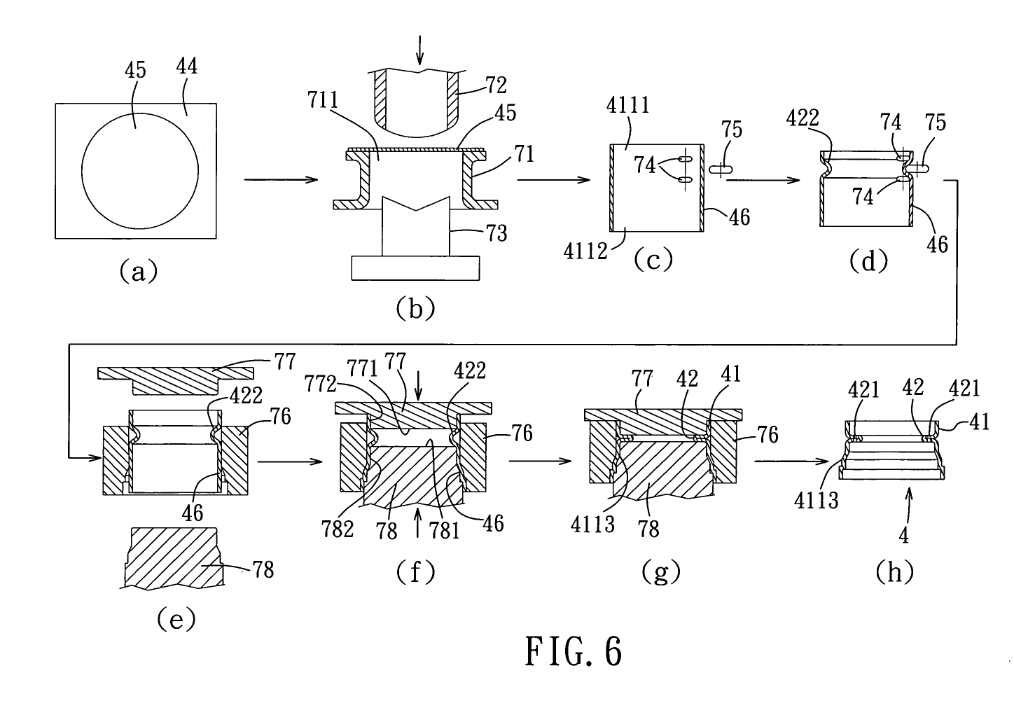

FIG. 6 illustrates the steps involved in making the vehicle wheel rim according to the method of the present invention. These steps will be described in greater detail below with reference to FIGS. 4 to 6.

In step (a), an aluminum alloy plate 44 is cut so as to form a circular metal plate 45. The circular metal plate 45 is unheat-treated, and has a diameter of, for example, about 958 mm and a thickness of about 6˜7 mm. The aluminum alloy is preferably an aluminum-magnesium alloy.

In step (b), the circular metal plate 45 undergoes a deep drawing process. In particular, the circular metal plate 45 is placed over an opening of a cavity 711 of a drawing die 71, after which the circular metal plate 45 is forced into the cavity 711 of the drawing die 71 using a punch 72, thereby forming a substantially cylindrical blank having the first openend portion 4111. The cylindrical blank is then cut using a cutter 73 that moves into the cavity 711 of the drawing die 71 opposite to the punch 72, so that the cylindrical blank 46 [see step (c)] is formed with the second open end portion 4112, and has a diameter of, for example, about 508 mm.

In steps (c) and (d), the cylindrical blank 46 is removed from the drawing die 71, and a pair of inner rollers 74 are placed within the cylindrical blank 46, and an outer roller 75 is placed at an outer side of the cylindrical blank 46. The inner rollers 74 are rotatable about an axis substantially parallel to an axis of the cylindrical blank 46, and are spaced apart axially from each other and radially from the axis of the cylindrical blank 46. The outer roller 75 is rotatable about an axis substantially parallel to the axis of the cylindrical blank 46. When the inner and outer rollers 74, 75 are activated, the outer roller 75 is moved toward the inner rollers 74 so that a ring portion 422 of the cylindrical blank 46 between the first and second open end portions 4111, 4112 is bent between the inner rollers 74 inwardly and substantially radially.

In step (e), the cylindrical blank 46 that has been bent is placed into a cavity of a mold 76.

In step (f), an upper press member 77 and a lower press member 78 are respectively forced into the first and second open end portions 4111, 4112 of the cylindrical blank 46. The upper and lower press members 77, 78 respectively have end faces 771, 781 that are opposite to each other, and lateral faces 772, 782 transverse to the end faces 771, 781.

In step (g), the first and second open end portions 4111, 4112 are formed by pressing the first and second open end portions 4111, 4112 against a cavity wall of the mold 76 using the lateral faces 772, 782 of the upper and lower press members 77, 78. In addition, two opposite sides of the bent ring portion 422 are pressed to fully fold the ring portion 422 so as to form the annular protrusion 42 by the end faces 771, 781 of the upper and lower press members 77, 78, thereby forming the wheel rim body 41. The second open end portion 4112, after undergoing such formation, is enlarged and has the stepped portions 4113, whereas the first open end portion 4111 is formed with no stepped portion. However, the shapes of the first and second open end portions 4111, 4112 should not be limited thereto. For example, both of the first and second open end portions 4111, 4112 may be formed to have stepped portions.

In step (h), the wheel rim body 41 is removed from the mold 76, and is bored with a plurality of the angularly spaced-apart through holes 421. Finally, the wheel rim body 41 is subjected to a T6 solution heat-treatment process so as to increase its strength and to achieve a Rockwell hardness of above 20%.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of making a vehicle wheel rim, comprising:
deep drawing a metal plate to form a substantially cylindrical blank having two axially opposite first and second open end portions;
roll-bending a ring portion of the cylindrical blank between the first and second open end portions so that the ring portion is bent inwardly and substantially radially;
placing into a mold the cylindrical blank that has been bent;
forcing upper and lower press members respectively into the first and second open end portions of the cylindrical blank placed in the mold, the upper and lower press members respectively having end faces that are opposite to each other, and lateral faces transverse to the end faces; and
forming the first and second open end portions by pressing the first and second open end portions against a cavity wall of the mold using the lateral faces of the upper and lower press members, and pressing two opposite sides of the bent ring portion to form a folded annular protrusion using the end faces of the upper and lower press members, thereby providing a wheel rim body.

2. The method of claim 1, wherein the deep drawing of the metal plate includes:
placing the metal plate over an opening of a cavity of a drawing die;
forcing the metal plate into the cavity of the drawing die using a punch to form the cylindrical blank having the first open end portion; and
cutting the cylindrical blank using a cutter that moves into the cavity of the drawing die opposite to the punch so that the cylindrical blank is provided with the second open end portion.

3. The method of claim 1, wherein the roll-bending of the cylindrical blank includes:
placing within the cylindrical bank a pair of inner rollers that are rotatable about an axis substantially parallel to an axis of the cylindrical bank and proximate to the ring portion and that are spaced apart axially from each other;
placing at an outer side of the cylindrical bank an outer roller that is rotatable about an axis substantially parallel to the axis of the cylindrical bank and proximate to the ring portion; and
moving the outer roller toward the inner rollers so that the ring portion is bent between the inner rollers.

4. The method of claim 1, further comprising the step of heat-treating the wheel rim body, wherein the metal plate is made of an aluminum alloy which is unheat-treated.

5. The method of claim 4, wherein the aluminum alloy is an aluminum-magnesium alloy.
